(19) United States
(12) Patent Application Publication
(10) Pub. No.: US 2026/0065649 A1
(43) Pub. Date: Mar. 5, 2026

(54) SELF-TRAINING ON UNPAIRED DATA FOR VISION-LANGUAGE MODELS

(71) Applicant: ADOBE INC., SAN JOSE, CA (US)

(72) Inventors: Lang Huang, Tokyo (JP); Zichuan Liu, San Jose, CA (US); Ratheesh Kalarot, San Jose, CA (US)

(21) Appl. No.: 18/825,123

(22) Filed: Sep. 5, 2024

(51) Int. Cl. G06V 10/774; G06F 40/40; G06V 10/776

(52) U.S. Cl. CPC G06V 10/774; G06F 40/40; G06V 10/776

(57) ABSTRACT

A method, apparatus, non-transitory computer readable medium, and system for caption generation includes obtaining training data including an input image depicting a scene and training, using the training data, a captioning model to generate a text caption describing the scene. Training the captioning model comprises training an image encoder of the captioning model to encode the input image to obtain an image embedding representing the scene and training a language decoder of the captioning model to generate the text caption based on the image embedding, wherein the captioning model is trained based on an output of the language decoder.

### BACKGROUND

The following relates generally to machine learning, and more specifically to image captioning. Image captioning involves elements of image processing and natural language processing. Image processing refers to techniques for using computer systems, including machine learning models to analyze, edit, or generate images. Natural language processing (NLP) refers to techniques for using computers to interpret or generate natural language. In some cases, NLP tasks involve assigning annotation data such as grammatical information to words or phrases within a natural language expression.

Image captioning refers to the machine learning task of generating a textual description (i.e., a caption) of an image. For example, words in a caption can be used to index an image so that it can be easily retrieved from an image search database. Existing deep learning based approaches for image captioning train an image-conditioned language model on an image-caption dataset. However, existing methods use manually intensive methods for creating training data and are hence not able to provide high-quality or relevant captions at a large-scale.

### SUMMARY

The present disclosure described systems and methods for captioning an image based on a captioning model that is trained using paired and unpaired image data. In some examples, a caption is generated for an image using the trained captioning model. A training caption and the corresponding training image are encoded, and the captioning network generates an augmented caption based on the content of the training image. In some cases, a training component computes a loss function based on the training caption and the corresponding training image to update parameters of the captioning network.

A method, apparatus, and non-transitory computer readable medium for image captioning are described. One or more aspects of the method, apparatus, and non-transitory computer readable medium include obtaining training data including an input image depicting a scene and training, using the training data, a captioning model to generate a text caption describing the scene. Training the captioning model comprises training an image encoder of the captioning model to encode the input image to obtain an image embedding representing the scene and training a language decoder of the captioning model to generate the text caption based on the image embedding, wherein the captioning model is trained based on an output of the language decoder.

A method, apparatus, and non-transitory computer readable medium for image captioning are described. One or more aspects of the method, apparatus, and non-transitory computer readable medium include obtaining training data including an input image; training, using the training data, a first captioning model to generate a synthetic caption based on the input image; generating an augmented caption based on the synthetic caption; and using the synthetic caption and the augmented caption to train a second captioning model.

A method, apparatus, and non-transitory computer readable medium for image captioning are described. One or more aspects of the method, apparatus, and non-transitory computer readable medium include obtaining an input image; encoding, using an image encoder of a captioning model, the input image to obtain an image embedding; and generating, using a language decoder of the captioning model, a text caption describing the input image, wherein the captioning model is trained using training data including a training image, a synthetic caption generated based on the training image, and an augmented caption generated based on the synthetic caption.

A method, apparatus, and non-transitory computer readable medium for image captioning are described. One or more aspects of the method, apparatus, and non-transitory computer readable medium include obtaining training data including a training image, a synthetic caption generated based on the training image, and an augmented caption generated based on the synthetic caption and training, using the training data, a captioning model to generate a text caption describing an input image.

An apparatus and system for image captioning are described. One or more aspects of the apparatus and system include at least one processor; at least one memory component coupled with the at least one processor; and a captioning model comprising parameters stored in the at least one memory component and trained to generate a text caption describing an input image, wherein the captioning model is trained by generating a synthetic caption, generating an augmented caption based on the synthetic caption, and training the captioning model using the synthetic caption and the augmented caption.

### BRIEF DESCRIPTION OF THE DRAWINGS

FIG. 1 shows an example of a natural language processing apparatus according to aspects of the present disclosure.

FIG. 2 shows an example of a method for generating a caption according to aspects of the present disclosure.

FIG. 3 shows an example of a caption generation process according to aspects of the present disclosure.

FIG. 4 shows an example of a captioning process according to aspects of the present disclosure.

FIG. 5 shows an example of a method for natural language processing according to aspects of the present disclosure.

FIG. 6 shows an example of a captioning model according to aspects of the present disclosure.

FIG. 7 shows an example of a caption refinement process according to aspects of the present disclosure.

FIG. 8 shows an example of a method for training a captioning model according to aspects of the present disclosure.

FIG. 9 shows an example of training a machine learning model according to aspects of the present disclosure.

FIG. 10 shows an example of a computing device according to aspects of the present disclosure.

FIG. 11 shows an example of a natural language processing apparatus according to aspects of the present disclosure.

FIG. 12 shows an example of a machine learning model according to aspects of the present disclosure.

### DETAILED DESCRIPTION

The present disclosure described systems and methods for image captioning. Embodiments include a captioning model that is trained using paired and unpaired image data. In some examples, a caption is generated for an image using the trained captioning model. A training caption and the corresponding training image are encoded and the captioning network generates an augmented caption based on the content of the training image. In some cases, a training component computes a loss function based on the training caption and the corresponding training image to update parameters of the captioning network.

Machine learning models are used to generate captions for an image and are thus useful for several text generation and editing applications. However, conventional machine learning systems rely on the availability of a high volume of image-caption pairs for training the models. In some cases, such high-volume image-caption pairs are challenging to collect and access. Additionally, the available image-caption pairs often include noisy data and require additional resources in data cleaning. Therefore, conventional machine learning models for caption generation are unable to provide high-quality captions that capture important information in a given image.

Embodiments of the present disclosure include a machine learning model that improves conventional captioning models by generating more accurate image captions. The increased accuracy can be achieved by an improved training process. For example, in some cases the machine learning model itself generates augmented training captions and uses the generated captions for further training. The training can be based on a contrastive loss function and a caption loss function.

Accordingly, by training the machine learning model based on the loss functions, embodiments of the present disclosure are able to provide a captioning model that can generate high quality captions for an image and can capture the essential information depicted in the image. Additionally, the machine learning model of the present disclosure has reduced reliability on availability of paired image-caption data. In some cases, the machine learning model aligns different modalities (i.e., both image and text-based) based on using unpaired data.

Embodiments of the present disclosure include a machine learning model configured to use the unpaired data for enhancing the alignment between images and captions. In some cases, the machine learning model iteratively trains a captioning model based on augmented captions for paired data. The trained captioning model is used to generate a synthetic caption for a new image and the captioning model is further trained based on the synthetic caption. Subsequently, a language generation model is used to combine the information in the synthetic caption and the training caption to obtain an augmented caption.

In some cases, the captioning model is trained alternatively with the augmented paired data and the unpaired data with synthetic captions derived from the data engine. The data engine synthesizes a diverse range of captions for each of the paired and unpaired images using the captioning model. Accordingly, by iteratively training the captioning model using the paired data and the unpaired data, embodiments of the present disclosure are able to enhance the performance of the captioning model and generate high-quality captions for an image. Additionally, by using the language generation model, embodiments generate a diverse range of captions for paired and unpaired image data.

Embodiments of the present disclosure include a captioning model configured to perform image caption alignment. In some cases, the captioning model includes an image encoder configured to encode an image to obtain a global embedding and local embeddings. Additionally, the captioning model includes a bidirectional language encoder configured to encode a training caption to obtain a global embedding and a unidirectional language decoder configured to predict a synthetic caption conditioned on the image local embeddings. In some cases, the captioning model is computed based on a captioning loss used to optimize the image encoder and the language decoder. In some cases, the captioning model is computed based on a contrastive loss used to optimize the image encoder and the language encoder. The captioning model is updated based on the captioning loss and the contrastive loss.

According to an embodiment, the captioning model is able to supplement the knowledge in web-based captions with insights that exhibit distinct characteristics. In some cases, a language generation model instructs the captioning model to generate a new caption by merging a caption scraped from the Internet with the synthetic caption. In some cases, the merged captions may be generated based on a user-provided prompt.

In some embodiments, the captioning model can generate captions that include important details from images by using image-text loss functions. Additionally, the captioning model can be guided based on the language generation model to obtain desired properties of the generated caption. In some examples, the captioning model may be fine-tuned based on data augmentation to enhance the training capabilities.

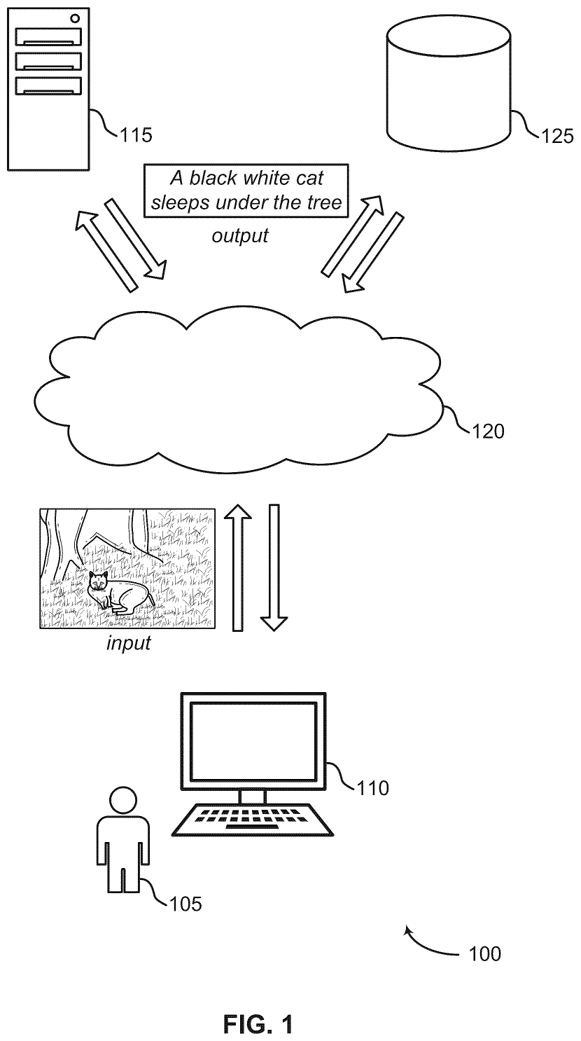

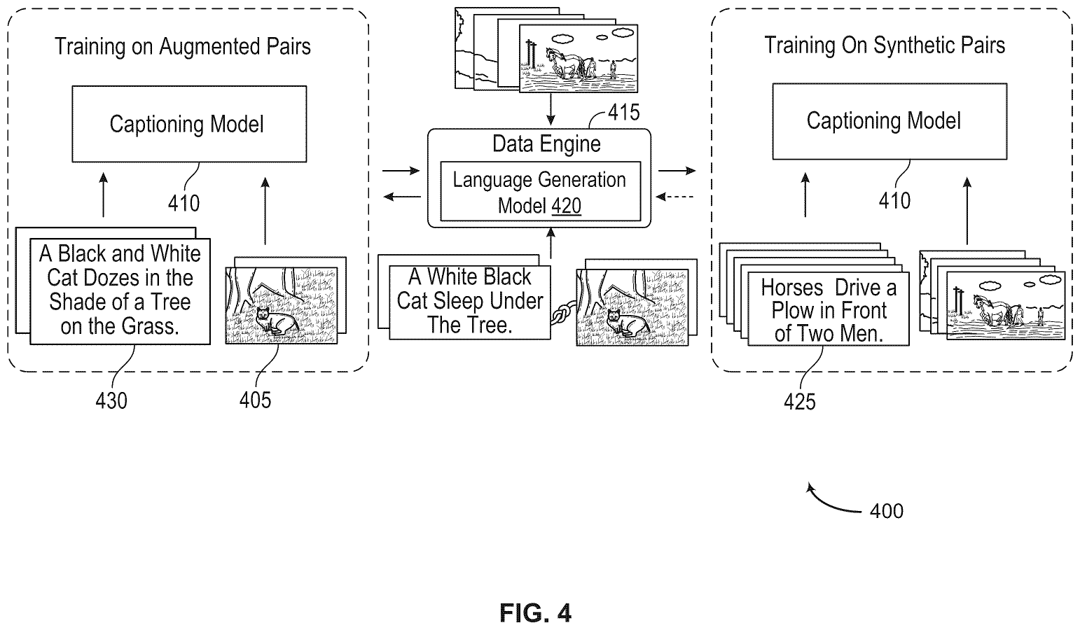

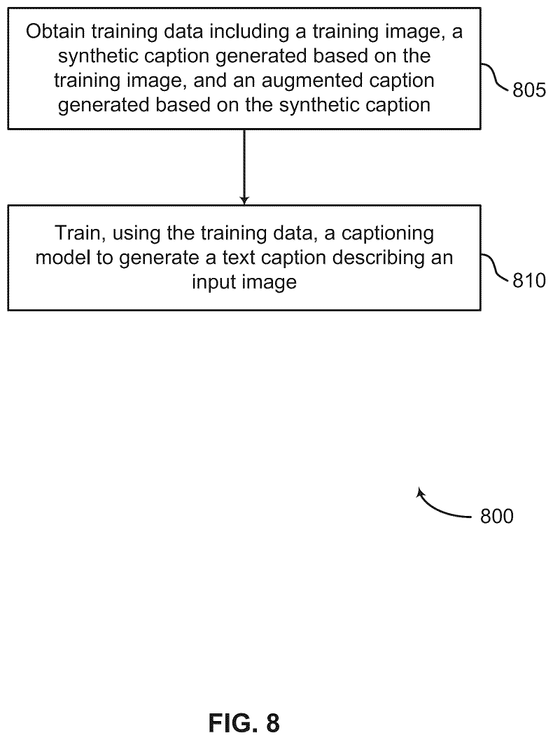

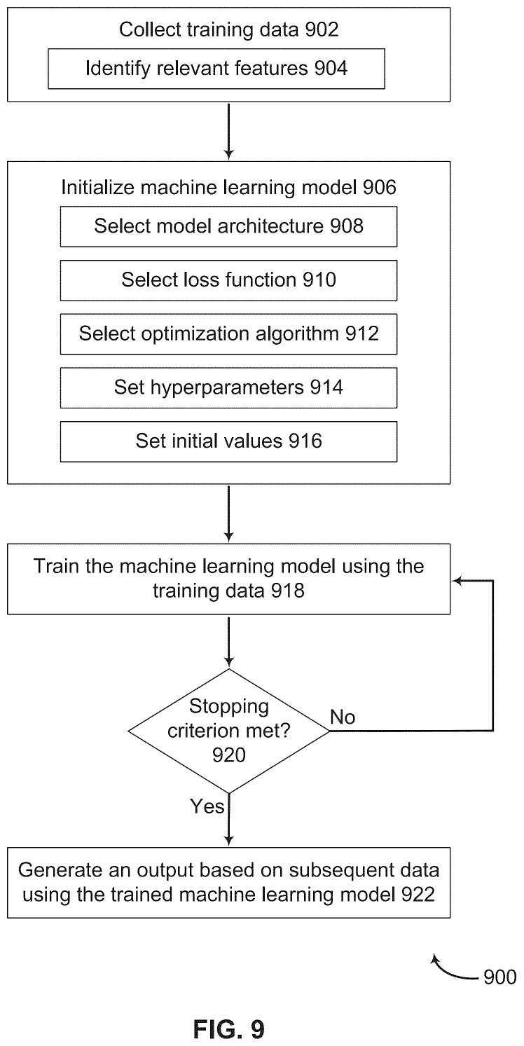

Embodiments of the present disclosure can be implemented in a self-trained image captioning model. For example, the captioning model based on the present disclosure takes an image (e.g., an image depicting an element) and efficiently generates a caption that accurately describes the content of the image. Example applications regarding generating a caption that describes an input image are provided with reference to FIGS. 1-3. Details regarding the architecture of the captioning system are provided with reference to FIGS. 4-7 and 10-12. Examples of a process for training an image generation model are provided with reference to FIGS. 8-9.

### Caption Generation System

A system and an apparatus for natural language processing are described with reference to FIGS. 1-4. FIG. 1 shows an example of a natural language processing apparatus 100 according to aspects of the present disclosure. In one aspect, natural language processing system 100 includes user 105, user device 110, natural language processing apparatus 115, cloud 120, and database 125.

In the example of FIG. 1, user 105 provides an image to natural language processing apparatus 115 via a user interface provided on user device 110 by natural language processing apparatus 115. In some cases, the image provided by the user depicts a scene. In some cases, the image provided by the user includes an element. As an example shown in FIG. 1, the user provides an image that the user wants to describe using the natural language processing apparatus 115 of the present disclosure. According to some aspects, natural language processing apparatus 115 obtains an input image, e.g., an image depicting a cat.

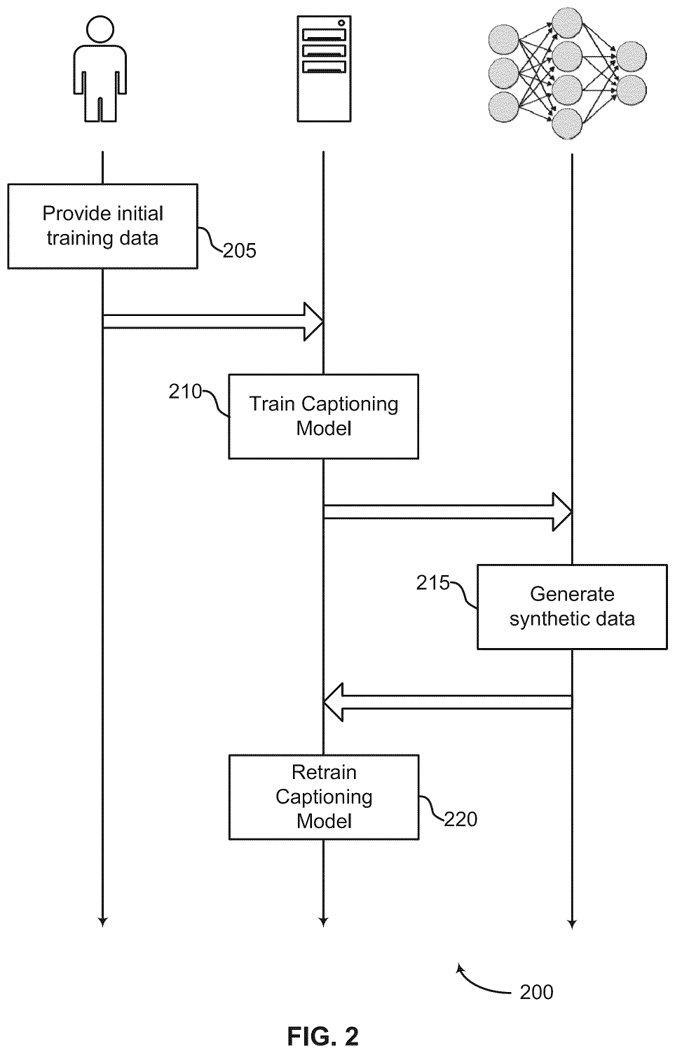

In some cases, the natural language processing apparatus 115 uses a machine learning model (such as the machine learning model described with reference to FIGS. 4 and 11-12) to generate a caption describing the input image. In some cases, as shown in FIG. 1, the user provides an image (e.g., depicting a black and white cat under a tree). In some cases, as shown in FIG. 2, in addition to the image, the user provides an instruction to modify the caption (e.g., merge the generated caption with a caption from the Internet). In some cases, the natural language processing apparatus 115 generates a modified caption that incorporates the aspects (e.g., a cat under a tree) depicted in the image into the caption. In some cases, the machine learning model generates a caption that describes the aspects of the image, e.g., a black white cat sleeps under the tree.

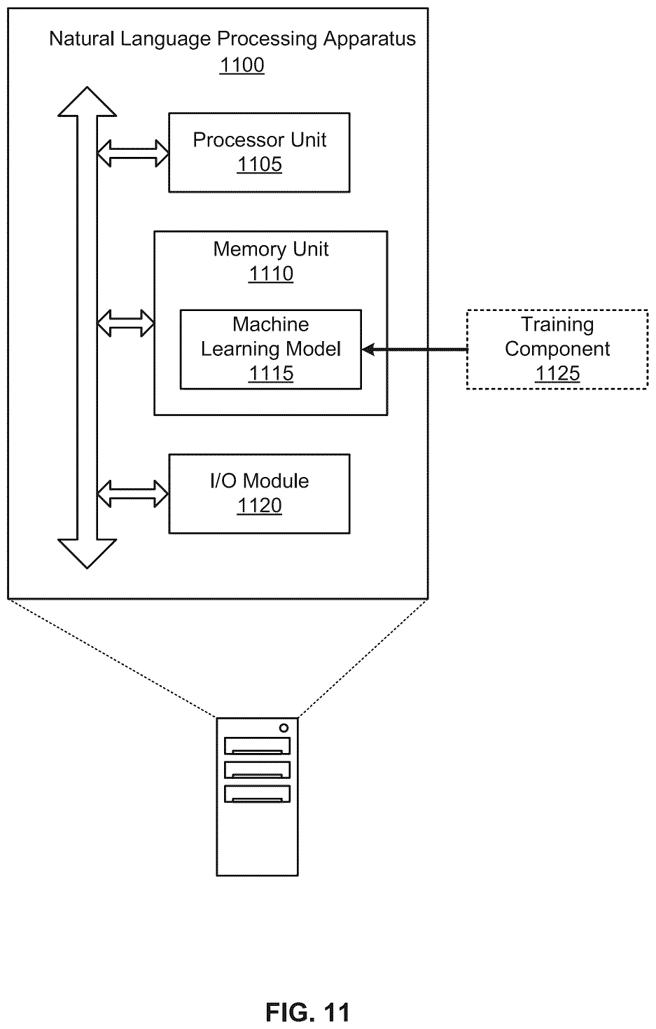

Referring to the example of FIG. 1, the natural language processing apparatus 115 provides the caption to user 105 via the user interface provided on user device 110. According to some aspects, user device 110 is a personal computer, laptop computer, mainframe computer, palmtop computer, personal assistant, mobile device, or any other suitable processing apparatus. In some examples, user device 110 includes software that displays a user interface (e.g., a graphical user interface) provided by natural language processing apparatus 115. In some aspects, the user interface provides for information (such as images, a caption, etc.) to be communicated between user 105 and natural language processing apparatus 115. Natural language processing apparatus 115 is an example of, or includes aspects of, the corresponding element described with reference to FIG. 11.

According to some aspects, a user device user interface enables user 105 to interact with user device 110. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

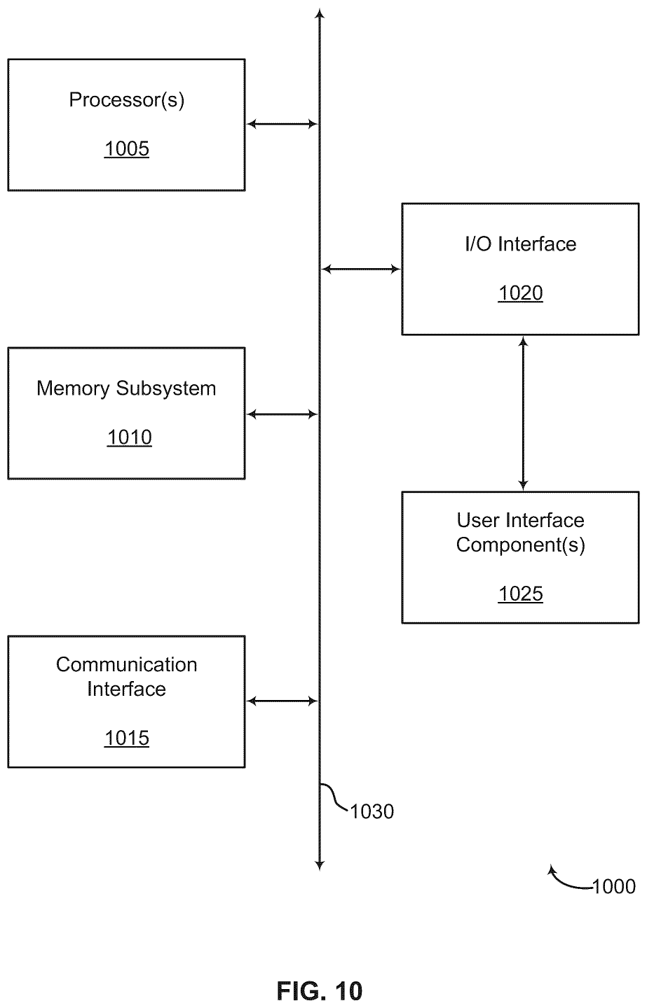

According to some aspects, natural language processing apparatus 115 includes a computer-implemented network. In some embodiments, the computer-implemented network includes a machine learning model (such as the machine learning model described with reference to FIG. 4). In some embodiments, natural language processing apparatus 115 also includes one or more processors, a memory subsystem, a communication interface, an I/O interface, one or more user interface components, and a bus as described with reference to FIG. 10. Additionally, in some embodiments, natural language processing apparatus 115 communicates with user device 110 and database 125 via cloud 120.

In some cases, natural language processing apparatus 115 is implemented on a server. A server provides one or more functions to users linked by way of one or more of various networks, such as cloud 120. In some cases, the server includes a single microprocessor board, which includes a microprocessor responsible for controlling all aspects of the server. In some cases, the server uses microprocessor and protocols to exchange data with other devices or users on one or more of the networks via hypertext transfer protocol (HTTP), and simple mail transfer protocol (SMTP), although other protocols such as file transfer protocol (FTP), and simple network management protocol (SNMP) may also be used. In some cases, the server is configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

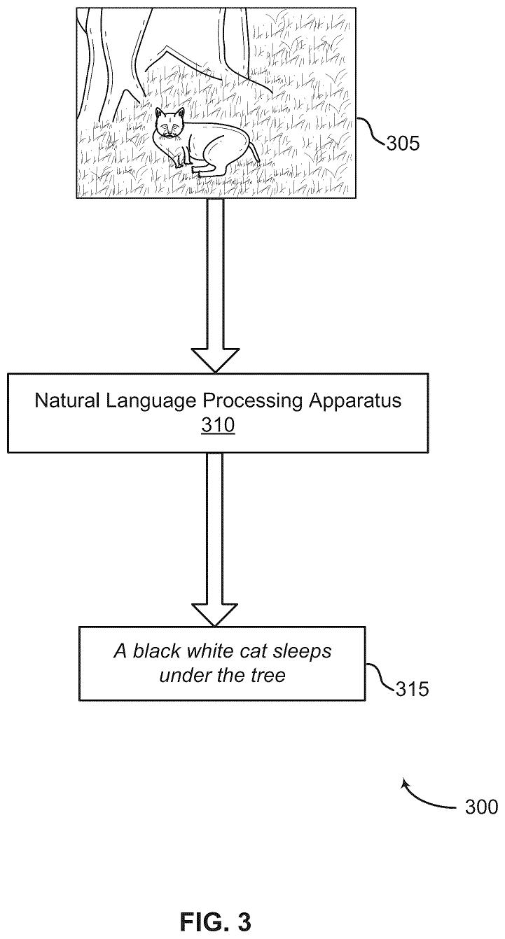

According to some aspects, natural language processing apparatus 100 obtains an input image. In some examples, natural language processing apparatus 100 obtains an input prompt. Natural language processing apparatus 100 is an example of, or includes aspects of, the corresponding element described with reference to FIG. 3.

Cloud 120 is a computer network configured to provide on-demand availability of computer system resources, such as data storage and computing power. In some examples, cloud 120 provides resources without active management by a user. The term “cloud” is sometimes used to describe data centers available to many users over the Internet. Some large cloud networks have functions distributed over multiple locations from central servers. A server is designated an edge server if it has a direct or close connection to a user. In some cases, cloud 120 is limited to a single organization. In other examples, cloud 120 is available to many organizations. In one example, cloud 120 includes a multi-layer communications network comprising multiple edge routers and core routers. In another example, cloud 120 is based on a local collection of switches in a single physical location. According to some aspects, cloud 120 provides communications between user device 110, natural language processing apparatus 115, and database 125.

Database 125 is an organized collection of data. In an example, database 125 stores data in a specified format known as a schema. According to some aspects, database 125 is structured as a single database, a distributed database, multiple distributed databases, or an emergency backup database. In some cases, a database controller manages data storage and processing in database 125. In some cases, a user interacts with the database controller. In other cases, the database controller operates automatically without interaction from the user. According to some aspects, database 125 is external to natural language processing apparatus 115 and communicates with natural language processing apparatus 115 via cloud 120. According to some aspects, database 125 is included in natural language processing apparatus 115.

FIG. 2 shows an example of a method 200 for generating a caption according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

According to an embodiment of the present disclosure, a natural language processing apparatus (such as the natural language processing apparatus described with reference to FIGS. 1 and 11-12) provides a machine learning model (such as the machine learning model described with reference to FIGS. 4 and 6-7) that generates a caption describing aspects represented in a user-provided image.

At operation 205, the system provides an initial training data. In some cases, the operations of this step refer to, or may be performed by, a user as described with reference to FIG. 1. In some examples, the user provides an initial training data including an image and a corresponding caption to the natural language processing apparatus (such as the natural language processing apparatus described with reference to FIG. 1).

In some cases, the image includes a plurality of elements that the user wants to describe, e.g., a cat. Additionally, the user provides a caption corresponding to the image that describes the color of the cat and the actions of the cat depicted in the image. In some cases, the user provides the image and the corresponding caption to the natural language processing apparatus via a user interface (such as a graphical user interface) provided on a user device by the natural language processing apparatus.

At operation 210, the system trains a captioning model. In some cases, the operations of this step refer to, or may be performed by, the natural language processing apparatus as described with reference to FIG. 4. In some cases, the natural language processing apparatus trains the captioning model based on the initial training data. For example, the initial training data is a paired image-caption dataset.

At operation 215, the system generates synthetic data. In some cases, the operations of this step refer to, or may be performed by, a captioning model as described with reference to FIG. 1. In some examples, the captioning model trained by the natural language processing apparatus (such as the natural language processing apparatus described with reference to FIG. 1) generates synthetic data for an image. For example, the captioning model generates a caption for a new image. As a result, the captioning model generates a new paired image-caption data.

In some cases, the captioning model generates a caption that may incorporate a web-scraped caption generated by the natural language processing apparatus based on an instruction provided by the user and the caption generated by the natural language processing apparatus. In some examples, the caption supplements the existing knowledge of web-scraped captions with a different insight. In some examples, the caption is generated based on a prompt such as “Combine a web-scraped caption with a synthesized one, giving precedence to the former”.

In some cases, the caption then serves as an in-context example. In some cases, the caption generated at operation 215 is coupled with a task description such as, “From a web-scraped caption ‘∥’ a synthesized caption, create a new caption after ‘=>’, favoring the web-scraped details and carefully adding from the synthesized one”. Further details regarding the generation of synthetic data is provided with reference to FIGS. 4 and 6-7.

At operation 220, the system retrains the captioning model. In some cases, the operations of this step refer to, or may be performed by, a natural language processing apparatus as described with reference to FIGS. 1 and 3. Additionally, the captioning model is retrained based on the new paired image-caption dataset that is generated based on unpaired image-caption dataset (as described in operation 215).

FIG. 3 shows an example of a caption generation process 300 according to aspects of the present disclosure. In one aspect, caption generation process 300 includes input image 305, natural language processing apparatus 310, and caption 315.

Input image 305 is an example of, or includes aspects of, the corresponding element described with reference to FIGS. 1, 4, and 6. According to an aspect, input image 305 includes an element. For example, input image 305 depicts an action performed by the element. Referring to the example shown in FIG. 3, the input image 305 depicts an element, such as a black and white cat. Additionally, as seen in FIG. 3, input image 305 shows an action performed by the element, such as the cat is sleeping. The input image 305 depicts a background (e.g., a tree).

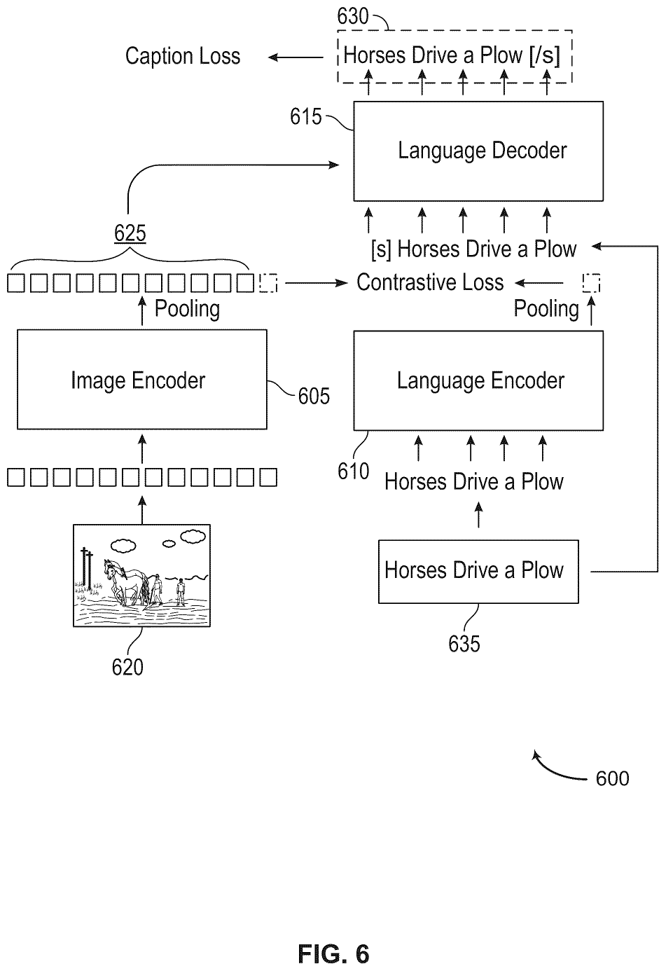

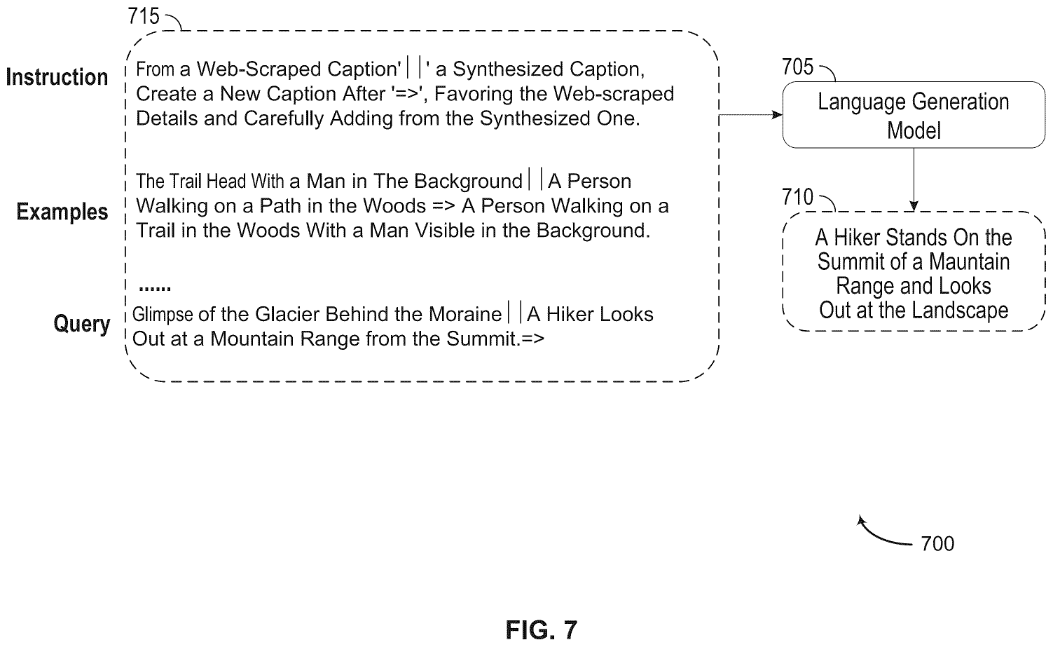

Natural language processing apparatus 310 is an example of, or includes aspects of, the corresponding element described with reference to FIG. 1. In some cases, the natural language processing apparatus 310 processes the input image 305 and describes aspects of the image 305 in caption 315. According to an embodiment, the natural language processing apparatus 310 further modifies the caption (using a process such as described in operations 215 and 220 in FIG. 2) to generate a fine-tuned caption 315 as desired by the user. For example, as shown in FIG. 3, the natural language processing apparatus 310 generates “A black white cat sleeps under the tree” as caption 315 or as fine-tuned caption 315. Caption 315 is an example of, or includes aspects of, the corresponding element described with reference to FIGS. 6 and 7.

Embodiments of the present disclosure are configured to provide a generic framework that uses unpaired image-caption data for enhancing vision language alignment. In some cases, the unpaired image-caption data refers to images that are not (e.g., correctly) paired with a caption. In some cases, a captioning model is integrated with a data engine, operating in a loop within the generic framework. By integrating the captioning model with the data engine, embodiments of the present disclosure significantly enhance the performance of the captioning model and the quality of the data.

According to an embodiment, a data engine is used to generate a diverse range of captions for paired and unpaired images. As used herein, the paired images refer to images that are correctly paired with a caption. Unpaired images refer to images that are not (e.g., correctly) paired with a caption. By leveraging language generation models, embodiments of the present disclosure are able to effectively integrate the information of web-scraped and synthetic captions. Additionally, by generating a diverse range of captions, embodiments of the present disclosure are able to enhance the quality of paired data.

FIG. 4 shows an example of a captioning process 400 according to aspects of the present disclosure. In one aspect, captioning process 400 includes input image 405, captioning model 410, data engine 415, language generation model 420, synthetic caption 425, and augmented caption 430. Input image 405 is an example of, or includes aspects of, the corresponding element described with reference to FIGS. 3 and 6.

Embodiments of the present disclosure include a captioning model (such as captioning model 410) that is alternately trained on two types of data. In some cases, captioning model 410, instantiated by transformers, is trained on a small-scale paired data, augmented by data engine 415 using a language generation model 420. In some cases, captioning model 410, instantiated by transformers, is trained on unpaired data, each of which is exclusively paired with multiple synthetic captions synthesized by data engine 415. In some cases, each of the paired and unpaired data are sourced from the data engine 415, resulting in diverse and comprehensive training supervision.

Additionally, embodiments include a data engine 415 that is configured to generate a plurality of captions for paired and unpaired data. In some cases, the captions for paired and unpaired data are generated using captioning model 410. In some cases, the data engine 415 integrates synthetic captions with captions scraped from the web. A language generation model 420 enables the integration of synthetic captions and web-scraped captions, ensuring high quality and contextually appropriate captions.

According to an embodiment, the model architectures are identical with the training stages. For example, as shown in FIG. 4, the architecture of the captioning model 410 and language generation model 420 are the same within the stages of training on augmented pairs and the training on synthetic pairs. In some cases, the captioning model 410 and language generation model 420 are trained based on different training data, i.e., paired data and synthetically paired data, respectively. In some examples, the language generation model 420 is included in data engine 415. In some examples, the language generation model 420 is an off-the-shelf large language model (LLM).

LLMs work by processing vast amounts of text data during the training phase. LLMs learn patterns, relationships between words, and how to predict the next word or phrase based on context. LLMs are trained on enormous datasets, such as books, articles, websites, and other written material and use the data to learn the statistical relationships between words and phrases. Text input is divided into smaller units called tokens, such as words or subwords. Each token has an associated vector representation that the model uses to understand and generate text. The model analyzes sequences of tokens to understand the context of each word or phrase which enables generation of text that is coherent and contextually appropriate.

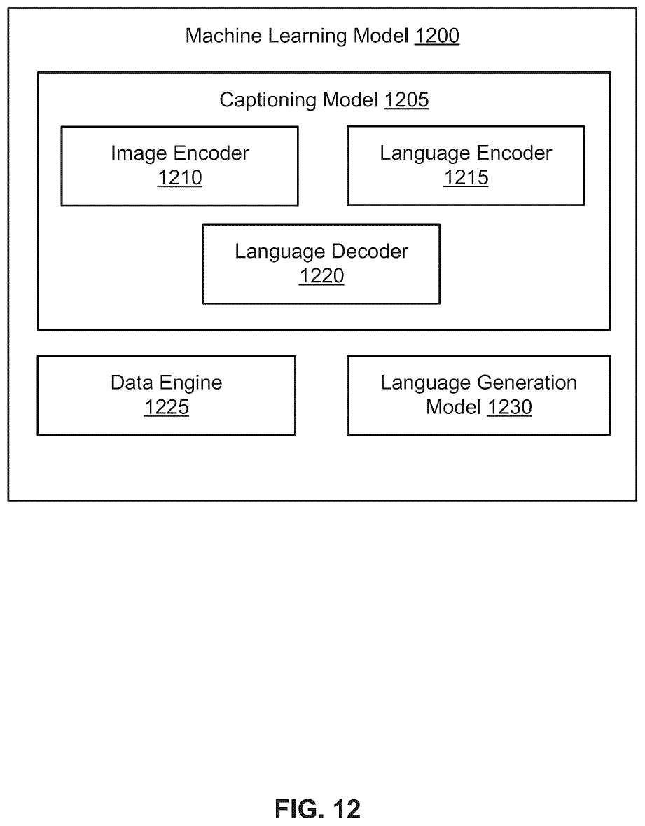

According to some aspects, captioning model 410 comprises parameters stored in the at least one memory component and trained to generate a text caption describing an input image 405 using training data including a training image, a synthetic caption 425 generated based on the training image, and an augmented caption 430 generated based on the synthetic caption 425. Captioning model 410 is an example of, or includes aspects of, the corresponding element described with reference to FIGS. 6 and 12.

As used herein, the training image includes paired image data and unpaired image data. In some cases, a paired training data refers to a training image that is associated with a caption. Additionally, in some cases, an unpaired training data refers to a training image that is not associated or is incorrectly associated with a caption.

As shown with reference to FIG. 4, the captioning process 400 operates in a loop. In some cases, the process 400 includes training the captioning model 410 alternatively on paired and unpaired data, augmented by the data engine 415. According to some aspects, data engine 415 is configured to generate the training data. Data engine 415 is an example of, or includes aspects of, the corresponding element described with reference to FIG. 12.

According to an embodiment, captioning process 400 begins by augmenting an initial, small-scale paired dataset with data engine 415, where data engine 415 takes image-text pairs as input and uses language generation model 420 to generate the augmented caption 430. Language generation model 420 is an example of, or includes aspects of, the corresponding element described with reference to FIGS. 7 and 12.

Further, captioning model 410 is trained based on the augmented caption 430 by implementing an empirical risk minimization process. In some cases, there are a plurality of captions (including augmented caption 430) associated with an image. According to an embodiment, one caption of the plurality of captions 430 is uniformly sampled at random. In some cases, captioning model 410 that is trained based on paired data is used to generate synthetic caption 425 based on the content of the image.

In some cases, the captioning model 410 is trained on unpaired dataset supplemented with a synthetic caption. Further, the captioning model 410 is used to synthesize a new set of captions for the paired data, generating captions for each image in the paired data. Once the synthetic caption 425 is generated, language generation model 420 is prompted to merge the information in the synthetic caption 425 and the original caption resulting in generation of augmented caption 430.

In some cases, as captioning process 400 approaches the end of a loop, embodiments of the present disclosure conclude the iteration. In some cases, as captioning process 400 approaches the end of a loop, embodiments of the present disclosure retrain the captioning model 410 which provides for the captioning process 400 to continue in a loop. Accordingly, captioning process 400 includes a dynamic and synergistic loop, alternating between captioning model training and data synthesis.

In some cases, data engine 415 is configured to synthesize diversified captions for the paired image caption data and unpaired image data using captioning model. In some cases, synthetic caption 425 and a caption scraped from the Internet are merged to enhance the quality of paired data using language generation model (such as language generation model 420). The dotted arrow in FIG. 4 indicates that the captioning model 410 is not involved in the first step of the iteration. Further details regarding web-scraped captions are provided with reference to FIG. 7.

Therefore, the captioning process is performed to generate synthetic captions from a paired image-caption data and augmented caption generated by language generation model to train the captioning model. In some cases, the augmented caption is generated at the beginning of the caption generation process (such as caption generation process 400), i.e., prior to generation of the synthetic captions. During later stages of the caption generation process, the trained captioning model generates synthetic captions for the training images. Additionally, an augmented caption is generated (e.g., augmented caption is generated again) by instructing the language generation model to combine the information from the synthetic caption and the caption from the paired image-caption data.

Accordingly, an apparatus for image captioning is described. One or more aspects of the apparatus include at least one processor; at least one memory component coupled with the at least one processor; and a captioning model comprising parameters stored in the at least one memory component and trained to generate a text caption describing an input image using training data including a training image, a synthetic caption generated based on the training image, and an augmented caption generated based on the synthetic caption.

Some examples of the apparatus and system further include a data engine configured to generate the training data. In some aspects, the captioning model comprises an image encoder configured to encode the input image to obtain an image embedding. In some aspects, the captioning model comprises a language encoder configured to encode an input prompt to obtain a text embedding. In some aspects, the captioning model comprises a language decoder configured to generate a text caption describing the input image. Some examples of the apparatus and system further include a language model configured to generate the augmented caption.

### Caption Generation Process

Embodiments of the present disclosure include a captioning process that incorporates unpaired data to train a captioning model. Accordingly, by training the captioning model using unpaired data, embodiments of the present disclosure need a small amount of image-caption data pairs to perform the training and provide for explicit control of the quality of the synthetic captions. In some cases, the captioning process (such as captioning process 400 described with reference to FIG. 4) markedly enhances the vision-language alignment within the captioning model. Additionally, the captioning process substantially enhances the quality of captions across image-text datasets.

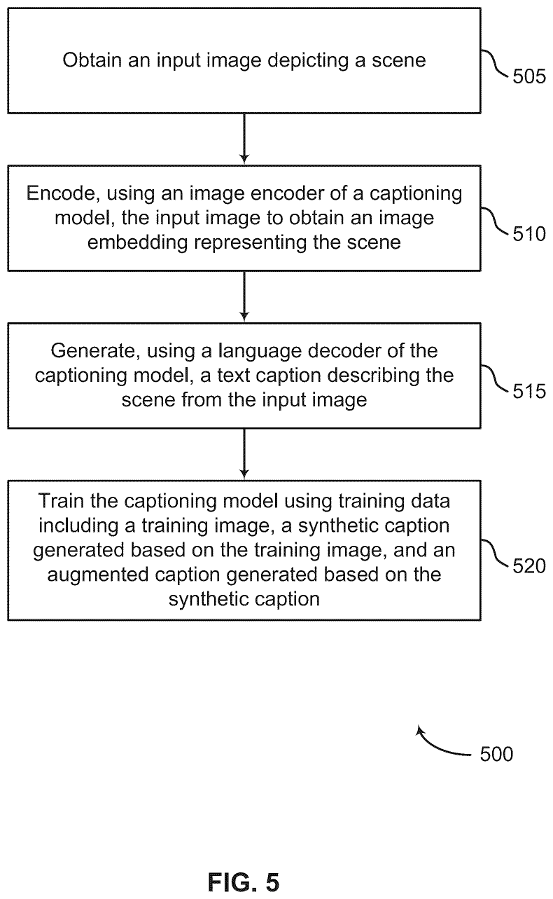

FIG. 5 shows an example of a method 500 for natural language processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 505, the system obtains an input image depicting a scene. In some cases, the operations of this step refer to, or may be performed by, a natural language processing apparatus as described with reference to FIGS. 1 and 3.

For example, in some cases, the natural language processing apparatus receives the input image from a user (such as the user described with reference for FIG. 1) or by retrieval from a database (such as the database described with reference to FIG. 1) or other data source. In some cases, the image depicts a scene. In some cases, the scene includes a plurality of elements (e.g., objects). Additionally, in some cases, the natural language processing apparatus receives a custom image from the user or database or any other data source.

At operation 510, the system encodes, using an image encoder of a captioning model, the input image to obtain an image embedding representing the scene. In some cases, the operations of this step refer to, or may be performed by, an image encoder as described with reference to FIGS. 6 and 12.

At operation 515, the system generates, using a language decoder of the captioning model, a text caption describing the scene from the input image. In some cases, the operations of this step refer to, or may be performed by, a language decoder as described with reference to FIGS. 6 and 12.

According to an embodiment of the present disclosure, captioning model (such as captioning model described with reference to FIGS. 4 and 8) comprises the image encoder, language encoder, and language decoder. In some cases, the image encoder is configured to encode the image into a global embedding for contrasting and a plurality of local embeddings for captioning. In some cases, the language encoder (e.g., a bidirectional language encoder) is configured to encode the caption into a global embedding for contrasting. Additionally, a language decoder (e.g., a unidirectional language decoder) is trained to predict a next token, conditioned on the vision language embeddings.

In some cases, the image encoder Eᵥ takes an image x as input, and outputs a global embedding v_{g} and an array of local embeddings Vₗ. Additionally, the language encoder Eₜ is instantiated by a bidirectional transformer, generating a global embedding t_{g} for a given caption y. Further, the language decoder Dₜ is instantiated by a unidirectional transformer. In some cases, the language decoder Dₜ is used to process the input caption y with the causal masking scheme and conditions on the vision embedding Vₗ. Language decoder Dₜ is used to predict the next caption in the sequence (such as the sequence or loop described with reference to FIG. 4).

At operation 520, the system trains the captioning model using training data including a training image, a synthetic caption generated based on the training image, and an augmented caption generated based on the synthetic caption.

In some cases, the captioning model is trained based on a captioning process (such as the captioning process 400 described with reference to FIG. 4). According to an embodiment, the captioning model M is trained alternatively on paired and unpaired data [symbol] ₚ and [symbol] ᵤ, augmented by the data engine [symbol] to generate augmented data [symbol] ( [symbol] ₚ).

$$ℰ ( {𝒟}_{p} ; G ) = {\{ ( {x}_{i} , ℰ ( {y}_{i} ; G ) ) \}}_{i = 1}^{{N}_{p}} = {\{ ( {x}_{i} , {\{ {\hat{y}}_{i}^{j} : {\hat{y}}_{i}^{j} ∼ G ( y ) \}}_{j = 1}^{m} ) \}}_{i = 1}^{{N}_{p}} \qquad ( 1 )$$

where the data engine [symbol] takes an image-text pair as input and generates m captions {ŷ^{j}}ₘ that are augmented by language generation model (such as language generation model 420 described with reference to FIG. 4) for each image.

Further, the captioning model M is trained using augmented paired dataset [symbol] ( [symbol] ₚ) with Empirical Risk Minimization as:

$${M}_{p} = {arg min}_{M} {𝔼}_{( x , y ) ∼ ℰ ( {𝒟}_{p} )} ℒ ( x , y ; M ) \qquad ( 2 )$$

where [symbol] (⋅) is an objective function. Further details regarding the objective function are provided with reference to FIGS. 6 and 8. In some cases, the subscript of M differentiates models trained with paired data (as Mₚ) and unpaired data (as Mᵤ).

Next, based on the captioning model trained with paired data (Mₚ), data engine [symbol] can be empowered for the images in [symbol] ᵤ.

$${ℰ ( {𝒟}_{u} ; {M}_{p} ) = \{ {x}_{i} , ℰ ( {x}_{i} ; {M}_{p} ) ) \}}_{i = 1}^{{N}_{u}} \qquad ( 3 )$$

$$= {\{ {x}_{i} , {\{ {\hat{y}}_{i}^{j} : {\hat{y}}_{i}^{j} ∼ {M}_{p} ( {x}_{i} ) \}}_{j = 1}^{m} \}}_{i = 1}^{{N}_{p}} \qquad ( 4 )$$

Here, Mₚ(x) generates a caption based on the content of the image x.

The captioning model is trained on the unpaired dataset supplemented with synthetic captions (such as synthetic captions 425 described with reference to FIG. 4) using the objective in Equation 2 to generate a model trained with unpaired data Mᵤ. Additionally, the model trained with unpaired data Mᵤ is used to synthesize a new set of captions for the paired data, generating m captions for each image in [symbol] ₚ using Equation 3.

In some cases, the language generation model is prompted to merge the information of the synthetic caption ŷₛ (i.e., after the synthetic captions are generated) and original caption ŷₒ as:

$${\tilde{y}}_{i} = G ( {\hat{y}}_{o} , {\hat{y}}_{s} ) , ∀ {x}_{i} \qquad ( 5 )$$

$${\hat{y}}_{o} ∼ G ( {y}_{i} ) , {\hat{y}}_{s} ∼ {M}_{u} ( {x}_{i} ) , \qquad ( 6 )$$

As a result, an augmented paired data

$$ℰ ( {𝒟}_{u} ; {M}_{p} , G ) = {\{ {x}_{i} {\{ {\tilde{y}}_{i}^{j} \}}_{j = 1}^{m} \}}_{i = 1}^{{N}_{p}}$$

is generated. The training process and the data synthesis are performed alternatively in a loop process (such as the iterative process described with reference to FIG. 4), where each process complements and enhances the remaining processes.

According to an embodiment, the captioning process (such as the captioning process 400 described with reference to FIG. 4) is a generic framework and is agnostic to the architecture of the captioning model. In some cases, the captioning model is instantiated due to the simplicity and capability to generate descriptive captions for use in vision-language learning.

FIG. 6 shows an example of a captioning model 600 according to aspects of the present disclosure. Captioning model 600 is an example of, or includes aspects of, the corresponding element described with reference to FIGS. 4 and 12.

In one aspect, captioning model 600 includes image encoder 605, language encoder 610, and language decoder 615. In some cases, captioning model 600 takes input image 620, generates image embedding 625 using image encoder 605, and text caption 630 using language encoder 610 and language decoder 615.

Accordingly, the system encodes, using an image encoder 605 of a captioning model 600, the input image 620 to obtain an image embedding 625. In some examples, image encoder 605 generates a set of local embeddings corresponding to a set of regions of the input image 620, respectively, where the image embedding 625 includes one of the set of local embeddings.

Referring to FIG. 6, image encoder 605 is instantiated by a vision transformer. In some cases, image encoder takes an image x as input and outputs a global embedding v_{g} and an array of local embeddings Vₗ. Image encoder 605 is an example of, or includes aspects of, the corresponding element described with reference to FIG. 12.

Additionally, the language encoder 610 Eₜ is instantiated by a bidirectional transformer, generating a global embedding t_{g} for a given caption 635 y. Further, the language decoder 615 Dₜ is instantiated by a unidirectional transformer. In some cases, the language decoder 615 Dₜ is used to process the input caption 635 y with the causal masking scheme and conditions on the image embedding 625 Vₗ.

In some aspects, the image embedding 625 and the text embedding are in a same embedding space. According to some aspects, the system encodes, using a language encoder 610 of the captioning model 600, the input prompt 635 to obtain a text embedding. In some aspects, the captioning model 600 includes a language encoder 610 configured to encode an input prompt 635 to obtain a text embedding. Language encoder 610 is an example of, or includes aspects of, the corresponding element described with reference to FIG. 12.

According to some aspects, the system generates, using a language decoder 615 of the captioning model 600, a text caption 630 describing the input image 620, where the captioning model 600 is trained using training data including a training image, a synthetic caption 630 generated based on the training image, and an augmented caption generated based on the synthetic caption 630. In some examples, language decoder 615 autoregressively decodes the image embedding 625.

According to some aspects, language decoder 615 autoregressively generates a text caption 630. In some aspects, the captioning model 600 includes a language decoder 615 configured to generate a text caption 630 describing the input image 620. Language decoder 615 is an example of, or includes aspects of, the corresponding element described with reference to FIG. 12. Input image 620 is an example of, or includes aspects of, the corresponding element described with reference to FIGS. 3 and 4. Text caption 630 is an example of, or includes aspects of, the corresponding element described with reference to FIGS. 3 and 7.

An embodiment of the present disclosure is configured to use a pretrained, frozen image encoder. For example, DINOv2 may be used as an image encoder. In some cases, the image encoder is complemented by a randomly initialized, trainable attentional pooling layer on the pretrained encoder. In some examples, language segments (i.e., language encoder 610 Eₜ and language decoder 615 Dₜ of captioning model 600 M) are initiated with a pretrained T5 encoder-decoder. In some cases, an averaging pooling is used when extracting the global language embedding with the language encoder 610.

According to an embodiment, the weights of the image encoder 605, language encoder 610, and language decoder 615 are updated based on gradient descent. As a result, the captioning model 600 is fine-tuned for the captioning and contrasting. In some cases, the captioning model 600 is jointly trained with the contrastive loss and caption loss. Specifically, the image encoder 605 and language encoder 610 are optimized by the contrastive loss. Additionally, the image encoder 605 and language decoder 615 are autoregressively optimized by the caption loss.

Embodiments of the present disclosure are configured to use the trained captioning model to generate a plurality of captions for a given input image via a standard decoding process. In some cases, the trained captioning model M is used to generate m captions for a given input image x through standard autoregressive decoding defined as:

$$\tilde{y} = {arg max}_{\tilde{y}} {\prod }_{t = 1}^{T} P ( {\tilde{y}}_{t} \vert {\tilde{y}}_{1} , {\tilde{y}}_{2} , … {\tilde{y}}_{t - 1} ; {V}_{l} ) \qquad ( 7 )$$

where P(\tilde{y}ₜ|\tilde{y}₁, \tilde{y}₂, . . . \tilde{y}ₜ₋₁; Vₗ) is indicative of the t-th word in the caption, conditioned on the image local embedding Vₗ, and the previous words in the caption. T indicates the length of the caption.

The decoding process is terminated either when t≥T or when sampling an end of sequence token. In some cases, a standard deduplication process is applied for the generated text data (e.g., synthetic caption 630 described in FIG. 6). According to an example, a MinHash algorithm is applied to eliminate captions that are less than five tokens in length and captions that exhibit a Jaccard similarity greater than 0.7.

FIG. 7 shows an example of a caption refinement process 700 according to aspects of the present disclosure. In one aspect, caption refinement process 700 includes language generation model 705, text caption 710, and caption instruction 715. Language generation model 705 is an example of, or includes aspects of, the corresponding element described with reference to FIGS. 4 and 12. Text caption 710 is an example of, or includes aspects of, the corresponding element described with reference to FIGS. 3 and 6.

According to an embodiment, the data engine E augments the existing captions for the paired data with the language generation model 705. For example, the language generation model 705 is a LLaMa-2-7B, i.e., independent of the presence of the captioning model M. In some cases, language generation model 705 receives instructions to “rewrite the caption differently”, supplemented by a plurality of in-context examples (e.g., ChatGPT) or by a user.

In some cases, the captioning model M is used to supplement the existing knowledge found in web-scraped captions with novel insights. In some cases, text caption 710 exhibit distinct characteristics. For example, a synthetic caption demonstrates greater consistency and coherence with the visual content but lack diversity. Similarly, raw captions, while offering semantically richer context, are susceptible to noise during the web-scraping process.

Accordingly, embodiments of the present disclosure include a caption refinement process that directs the language generation model to adeptly integrate the valuable elements from synthetic and raw captions, thereby creating more comprehensive and enriched caption. In some examples, the caption refinement process, such as caption refinement process 700, randomly selects 20 captions from the paired dataset [symbol] ( [symbol] ₚ, G) (i.e., images along with the corresponding synthetic captions).

As shown in FIG. 7, the caption refinement process 700 includes providing a caption instruction 715 for each image-caption pair. For example, caption instruction 715 may be a prompt such as “Combine a web-scraped caption with a synthesized one, giving precedence to the former”. Next, the merged samples serve as in-context examples. Coupled with the task description, “From a web-scraped caption ‘∥’ a synthesized caption, create a new caption after ‘=>’, favoring the web-scraped details and carefully adding from the synthesized one”, and the specific query, embodiments are used to prompt the language generation model 705 to integrate the web-scraped and synthetic captions to generate a fine-tuned caption. For example, the fine-tuned caption is a high quality caption that describes an important element of the given image.

### Training

A method for generating captions for a given image is described with reference to FIGS. 8-9. Embodiments of the present disclosure include a natural language processing apparatus configured for vision-language alignment. In some cases, the natural language processing apparatus adeptly leverages the unpaired data to train a captioning model. In some cases, the natural language processing apparatus includes a synergistic and iterative process of model training and data synthesis, enhanced by the integration of a language generation model, thereby resulting in improved data quality and model performance.

FIG. 8 shows an example of a method 800 for training a captioning model according to aspects of the present disclosure. The operations of method 800 can be performed iteratively to train one or more captioning models.

Some examples include obtaining training data including an input image depicting a scene and training, using the training data, a captioning model to generate a text caption describing the scene. Training the captioning model comprises training an image encoder of the captioning model to encode the input image to obtain an image embedding representing the scene and training a language decoder of the captioning model to generate the text caption based on the image embedding, wherein the captioning model is trained based on an output of the language decoder.

Some examples include obtaining training data including an input image; training first captioning model using the training data; generating, using the first captioning model, a synthetic caption based on the input image; generating an augmented caption based on the synthetic caption; and training a second captioning model based on the synthetic caption and the augmented caption. The second captioning model can be a different machine learning model from the first captioning model. Alternatively, it can be an iterative updated of the first captioning model.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system obtains training data including a training image, a synthetic caption generated based on the training image, and an augmented caption generated based on the synthetic caption. In some cases, the operations of this step refer to, or may be performed by, a machine learning model as described with reference to FIG. 12.

According to an embodiment, the machine learning model (such as machine learning model 1115 described with reference to FIG. 11 or machine learning model 1200 described with reference to FIG. 12) utilizes paired training data (i.e., the training image and the synthetic caption generated based on the training image) and augmented caption (such as augmented caption 430 described with reference to FIG. 4) for training a captioning model (such as captioning model described with reference to FIGS. 4-6). In some cases, the machine learning model is operated in a loop that trains the captioning model alternatively on paired and unpaired data, augmented by the data engine (such as data engine 415 described with reference to FIG. 4).

At operation 810, the system trains, using the training data, a captioning model to generate a text caption describing an input image. In some cases, the operations of this step refer to, or may be performed by, a training component as described with reference to FIG. 11.

In some examples, the machine learning model trains the captioning model with paired training data using Empirical Risk Minimization (as described with reference to FIG. 4). Additionally, in some cases, the machine learning model retrains the captioning model with unpaired training data generated based on the captioning model. In some examples, the machine learning model trains the captioning model with unpaired training data using Empirical Risk Minimization (as described with reference to FIG. 4). Accordingly, the captioning model generates a text caption for an input image. Further details regarding the training process is described with reference to FIGS. 4-5.

Embodiments of the present disclosure include a captioning model comprising an image encoder, a language encoder, and a language decoder. In some cases, the image encoder Eᵥ is configured to encode the input training image into a global embedding for contrasting and local embeddings for captioning. In some cases, the bidirectional language encoder Eₜ is configured to encode a training caption into a global embedding for contrasting. In some cases, the unidirectional language decoder Dₜ is trained to predict a next token, conditioned on the vision local embeddings.

According to an embodiment, an averaging pooling is used to extract the global language embedding with the language encoder. Subsequently, gradient descent is performed to update the weights of the language encoder Eₜ and language decoder Dₜ, which fine-tunes the model for captioning and contrasting.

In some cases, the captioning model is jointly trained with the contrastive loss [symbol] _{con} and caption loss [symbol] _{cap} weighted by two hyperparameters a and B using:

$$ℒ ( x , y ; M ) = α * {ℒ}_{c o n} ( x , y ) + β * {ℒ}_{c a p} ( x , y ) \qquad ( 8 )$$

In some cases, the image encoder Eᵥ and language encoder Eₜ are optimized by the contrastive loss as:

$${ℒ}_{c o n} ( x , y ) = - {\sum }_{i = 1}^{N} log \frac{exp ( s i m ( {v}_{g}^{i} , {t}_{g}^{i} ) / τ )}{{\sum }_{j = 1}^{N} exp ( s i m ( {v}_{g}^{i} , {t}_{g}^{j} ) / τ )} - {\sum }_{i = 1}^{N} log \frac{exp ( s i m ( {t}_{g}^{i} , {v}_{g}^{i} ) / τ )}{{\sum }_{j = 1}^{N} exp ( s i m ( {t}_{g}^{i} , {v}_{g}^{j} ) / τ )} \qquad ( 9 )$$

where the first term accounts for the image-to-text contrastive loss and the second term accounts for the text-to-image contrastive loss, sim(⋅) denotes cosine similarity, τ is the temperature parameter scaling the logits, and N is the batch size.

According to an embodiment, the image encoder Eᵥ and language decoder Dₜ are autoregressively optimized by the caption loss using:

$${ℒ}_{c a p} ( x , y ) = - {\sum }_{i = 1}^{N} {\sum }_{t = 1}^{{T}_{i}} log p ( {y}_{t}^{i} \vert {y}_{1}^{i} , … {y}_{t - 1}^{i} ; {V}_{l}^{i} ) \qquad ( 10 )$$

where Tᵢ is the length of the caption

$${y}^{i} , {y}_{j}^{i}$$

is the j-th word in

$${y}^{i} \cdot p ( {y}_{t}^{i} \vert {y}_{1}^{i} , … {y}_{t - 1}^{i} ; {V}_{l}^{i} )$$

is the probability of the t-th word in the caption, conditioned on the image local embedding Vₗⁱ and the previous words in the caption.

FIG. 9 is a flow diagram depicting an algorithm as a step-by-step procedure 900 in an example implementation of operations performable for training a machine-learning model. In some embodiments, the procedure 900 describes an operation of the training component 1125 described for configuring the machine learning model 1115 as described with reference to FIG. 11. The procedure 900 provides one or more examples of generating training data, use of the training data to train a machine-learning model, and use of the trained machine-learning model to perform a task.

To begin in this example, a machine-learning system collects training data (block 902) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 904) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 906). Initialization of the machine-learning model includes selecting a model architecture (block 908) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 910). The loss function is utilized to measure a difference between an output of the machine-learning model (i.e., predictions) and target values (e.g., as expressed by the training data) to be used to train the machine-learning model. Additionally, an optimization algorithm is selected (912) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 914) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 918) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 920), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 920), the procedure 900 continues training of the machine-learning model using the training data (block 918) in this example.

If the stopping criterion is met (“yes” from decision block 920), the trained machine-learning model is then utilized to generate an output based on subsequent data (block 922). The trained machine-learning model, for instance, is trained to perform a task as described above and therefore once trained is configured to perform that task based on subsequent data received as an input and processed by the machine-learning model.

Accordingly, a method for image captioning is described. One or more aspects of the method include obtaining training data including a training image, a synthetic caption generated based on the training image, and an augmented caption generated based on the synthetic caption and training, using the training data, a captioning model to generate a text caption describing an input image.

Some examples of the method, apparatus, and non-transitory computer readable medium further include obtaining preliminary training data including the training image and an original caption. Some examples further include training, using the preliminary training data, a preliminary captioning model. Some examples further include generating the synthetic caption using the preliminary captioning model.

Some examples of the method, apparatus, and non-transitory computer readable medium further include generating the augmented caption using a language generation model. Some examples of the method, apparatus, and non-transitory computer readable medium further include identifying a positive pair comprising the training image and the synthetic caption or the augmented caption. Some examples further include identifying a negative pair comprising the training image and an additional caption corresponding to an additional training image different from the training image.

Some examples of the method, apparatus, and non-transitory computer readable medium further include computing a contrastive loss based on the positive pair and the negative pair. Some examples further include updating parameters of the captioning model based on the contrastive loss. In some aspects, an image encoder and a language encoder of the captioning model are updated based on the contrastive loss.

Some examples of the method, apparatus, and non-transitory computer readable medium further include autoregressively generating a predicted caption. Some examples further include computing a caption loss based on the predicted caption and the synthetic caption or the augmented caption. Some examples further include updating parameters of the captioning model based on the caption loss.

In some aspects, an image encoder and a language decoder of the captioning model are updated based on the caption loss. Some examples of the method, apparatus, and non-transitory computer readable medium further include iteratively training a preliminary captioning model, generating synthetic captions using the preliminary captioning model, generating augmented captions based on the synthetic captions, and retraining the preliminary captioning model.

### Implementation and Evaluation

An embodiment of the disclosure includes an evaluation of the natural language processing apparatus on a range of standard zero-shot classification and compositionality benchmarks with effectiveness in enhancing vision-language alignment. Accordingly, by performing vision-language alignment, embodiments of the present disclosure are able to improve the quality of the synthesized dataset. Additionally, embodiments are able to advance the compositional understanding of vision-language data of the captioning model.

An exemplary embodiment of the present disclosure is configured to generate captions for a dataset comprising image-text pairs sourced from the Internet. For example, a plurality of URL-caption pairs, amounting to approximately 20% of the paired datasets are used. In some cases, the remaining images in the sourced dataset are used as unpaired data. According to an example, five augmented caption, m=5, are generated. For example, the caption refinement process (such as that described with reference to FIG. 7) uses 7B version of LLaMa 2.

According to an exemplary embodiment, the evaluation is performed on the OpenCLIP codebase [22] with Python 2.0 and the automatic mixed precision training. In some cases, the input image undergoes a weak augmentation, i.e., random flip, random crop, and is then resized 224×224. The input text is tokenized by a SentencePiece tokenizer with a maximal length of 40 tokens. In some examples, base-size Transformers, i.e., ViT-Base/14 pretrained by DINOv2 for the vision encoder Eᵥ and T5-Base for the language encoder-decoder Eₜ, Dₜ. The captioning model is trained with AdamW optimizer, with a batch size of 2,048 for both images and texts, a weight decay set to 0.2, an initial τ set to 1/0.07, and the cosine annealing learning rate decay. The hyperparameters α, β are set to 1 and 2, respectively.

In some examples, the captioning model is trained for 128 epochs with a learning rate of 0.002. For example, the training process is adjusted by scaling down the gradient of the language encoder by a factor of 0.1. According to an exemplary embodiment, zero-shot evaluation method focuses on the top1 and/or top5 accuracy on ImageNet validation set to assess performance based on using 80 prompt templates. Subsequently, each image is classified based on the proximity between the global embeddings and the averaged text classifiers, effectively leveraging the learned associations between images and textual descriptions (e.g., captions).

In some cases, the captioning model of the present disclosure effectively utilizes unpaired data, thereby enhancing the compositional understanding in vision-language models. For example, the captioning model significantly outperforms existing methods with an equivalent amount of paired data. Additionally, by training the captioning model with multiple captions, embodiments of the present disclosure are able to enhance the quality of generated captions.

In some examples, the text-only caption augmentation significantly enhances the performance of the captioning model, the process of generating captions for paired data using the trained captioning model and subsequently merging the generated captions with original captions through language generation model (such as that described with reference to FIGS. 4-6) further enhances the quality of generated captions. Thus, the integration of more pretrained components consistently and significantly enhances model performance when trained on paired data and also improves the quality of the generated captions.

An exemplary embodiment of the present disclosure evaluates the effect of the number of loops (such as the loops described with reference to FIGS. 4 and 7) on model performance. In some cases, the performance of the captioning model improves progressively with respect to each training loop. For example, embodiments of the present disclosure use a single loop as the default, for efficiency.

FIG. 10 shows an example of a computing device 1000 according to aspects of the present disclosure. The computing device 1000 may be an example of the natural language processing apparatus 1100 described with reference to FIG. 11. In one aspect, computing device 1000 includes processor(s) 1005, memory subsystem 1010, communication interface 1015, I/O interface 1020, user interface component(s) 1025, and channel 1030.

In some embodiments, computing device 1000 is an example of, or includes aspects of, the machine learning model of FIG. 12. In some embodiments, computing device 1000 includes one or more processors 1005 that can execute instructions stored in memory subsystem 1010 to perform media generation.

According to some aspects, computing device 1000 includes one or more processors 1005. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1010 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1015 operates at a boundary between communicating entities (such as computing device 1000, one or more user devices, a cloud, and one or more databases) and channel 1030 and can record and process communications. In some cases, communication interface 1015 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1020 is controlled by an I/O controller to manage input and output signals for computing device 1000. In some cases, I/O interface 1020 manages peripherals not integrated into computing device 1000. In some cases, I/O interface 1020 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1020 or via hardware components controlled by the I/O controller.

According to some aspects, user interface component(s) 1025 enable a user to interact with computing device 1000. In some cases, user interface component(s) 1025 include an audio device, such as an external speaker system, an external display device such as a display screen, an input device (e.g., a remote-control device interfaced with a user interface directly or through the I/O controller), or a combination thereof. In some cases, user interface component(s) 1025 include a GUI.

FIG. 11 shows an example of a natural language processing apparatus 1100 according to aspects of the present disclosure.

According to some aspects, natural language processing apparatus 1100 obtains an input image. In some examples, natural language processing apparatus 1100 obtains an input prompt. In some embodiments, natural language processing apparatus 1100 includes processor unit 1105, memory unit 1110, machine learning model 1115, I/O module 1120, and training component 1125. Training component 1125 updates parameters of the machine learning model 1115 stored in memory unit 1110. In some examples, the training component 1125 is located outside the natural language processing apparatus 1100.

Processor unit 1105 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 1105 is configured to operate a memory array using a memory controller. In other cases, a memory controller is integrated into processor unit 1105. In some cases, processor unit 1105 is configured to execute computer-readable instructions stored in memory unit 1110 to perform various functions. In some aspects, processor unit 1105 includes special purpose components for modem processing, baseband processing, digital signal processing, or transmission processing. According to some aspects, processor unit 1105 comprises one or more processors described with reference to FIG. 10.

Memory unit 1110 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1105 to perform various functions described herein.

In some cases, memory unit 1110 includes a basic input/output system (BIOS) that controls basic hardware or software operations, such as an interaction with peripheral components or devices. In some cases, memory unit 1110 includes a memory controller that operates memory cells of memory unit 1110. For example, the memory controller may include a row decoder, column decoder, or both. In some cases, memory cells within memory unit 1110 store information in the form of a logical state. According to some aspects, memory unit 1110 is an example of the memory subsystem 1010 described with reference to FIG. 10.

According to some aspects, natural language processing apparatus 1100 uses one or more processors of processor unit 1105 to execute instructions stored in memory unit 1110 to perform functions described herein. For example, the natural language processing apparatus 1100 may obtain an input image; encode, using an image encoder of a captioning model, the input image to obtain an image embedding; and generate, using a language decoder of the captioning model, a text caption describing the input image, wherein the captioning model is trained using training data including a training image, a synthetic caption generated based on the training image, and an augmented caption generated based on the synthetic caption.

The memory unit 1110 may include a machine learning model 1115 trained to obtain an input image; encode, using an image encoder of a captioning model, the input image to obtain an image embedding; and generate, using a language decoder of the captioning model, a text caption describing the input image, wherein the captioning model is trained using training data including a training image, a synthetic caption generated based on the training image, and an augmented caption generated based on the synthetic caption. For example, after training, the machine learning model 1115 may perform inferencing operations as described with reference to FIGS. 1-3 to obtain an input image; encode, using an image encoder of a captioning model, the input image to obtain an image embedding; and generate, using a language decoder of the captioning model, a text caption describing the input image, wherein the captioning model is trained using training data including a training image, a synthetic caption generated based on the training image, and an augmented caption generated based on the synthetic caption.

In some embodiments, the machine learning model 1115 is an Artificial neural network (ANN) such as the guided diffusion model described with reference to FIG. 1 and the U-Net described with reference to FIG. 2. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of machine learning model 1115 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1125 may train the machine learning model 1115. For example, parameters of the machine learning model 1115 can be learned or estimated from training data and then used to make predictions or perform tasks based on learned patterns and relationships in the data. In some examples, the parameters are adjusted during the training process to minimize a loss function or maximize a performance metric (e.g., as described with reference to FIG. 9). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning model 1115 can be used to make predictions on new, unseen data (i.e., during inference).

I/O module 1120 receives inputs from and transmits outputs of the natural language processing apparatus 1100 to other devices or users. For example, I/O module 1120 receives inputs for the machine learning model 1115 and transmits outputs of the machine learning model 1115. According to some aspects, I/O module 1120 is an example of the I/O interface 1020 described with reference to FIG. 10.

According to some aspects, training component 1125 trains, using the training data, a captioning model to generate a text caption describing an input image. In some examples, training component 1125 trains, using the preliminary training data, a preliminary captioning model. In some examples, training component 1125 generates the synthetic caption using the preliminary captioning model. In some examples, training component 1125 computes a contrastive loss based on the positive pair and the negative pair. In some examples, training component 1125 updates parameters of the captioning model based on the contrastive loss. In some aspects, an image encoder and a language encoder of the captioning model are updated based on the contrastive loss.

In some examples, training component 1125 computes a caption loss based on the predicted caption and the synthetic caption or the augmented caption. In some examples, training component 1125 updates parameters of the captioning model based on the caption loss. In some aspects, an image encoder and a language decoder of the captioning model are updated based on the caption loss. In some examples, training component 1125 iteratively trains a preliminary captioning model, generating synthetic captions using the preliminary captioning model, generating augmented captions based on the synthetic captions, and retraining the preliminary captioning model.

FIG. 12 shows an example of a machine learning model 1200 according to aspects of the present disclosure.

Machine learning model 1200 is an example of, or includes aspects of, the corresponding element described with reference to FIG. 11. According to some aspects, machine learning model 1200 is implemented as software stored in a memory and executed by a processor (such as memory unit 1110 and processor unit 1105 described with reference to FIG. 11), as firmware, as one or more hardware circuits, or as a combination thereof.

According to some aspects, machine learning model 1200 obtains training data including a training image, a synthetic caption generated based on the training image, and an augmented caption generated based on the synthetic caption. In some examples, machine learning model 1200 obtains preliminary training data including the training image and an original caption. In some examples, machine learning model 1200 identifies a positive pair including the training image and the synthetic caption or the augmented caption. In some examples, machine learning model 1200 identifies a negative pair including the training image and an additional caption corresponding to an additional training image different from the training image.

In one aspect, machine learning model 1200 includes captioning model 1205, data engine 1225, and language generation model 1230. In some aspects, the image embedding and the text embedding are in the same embedding space.

According to some aspects, captioning model 1205 comprises parameters stored in the at least one memory component and trained to generate a text caption describing an input image using training data including a training image, a synthetic caption generated based on the training image, and an augmented caption generated based on the synthetic caption. In one aspect, captioning model 1205 includes image encoder 1210, language encoder 1215, and language decoder 1220.

According to some aspects, an image encoder 1210 of a captioning model 1205 encodes the input image to obtain an image embedding. In some examples, image encoder 1210 generates a set of local embeddings corresponding to a set of regions of the input image, respectively, where the image embedding includes one of the set of local embeddings.

In some aspects, the captioning model 1205 includes an image encoder 1210. According to some aspects, the image encoder 1210 is configured to encode the input image to obtain an image embedding.

In some aspects, the captioning model 1205 includes a language encoder 1215. According to some aspects, a language encoder 1215 of the captioning model 1205 encodes the input prompt to obtain a text embedding. In some aspects, the captioning model 1205 includes a language encoder 1215 configured to encode an input prompt to obtain a text embedding.

In some aspects, the captioning model 1205 includes a language decoder 1220. According to some aspects, a language decoder 1220 of the captioning model 1205 generates a text caption describing the input image, where the captioning model 1205 is trained using training data including a training image, a synthetic caption generated based on the training image, and an augmented caption generated based on the synthetic caption. In some examples, language decoder 1220 autoregressively decodes the image embedding.

According to some aspects, language decoder 1220 autoregressively generates a predicted caption. In some aspects, the captioning model 1205 includes a language decoder 1220 configured to generate a text caption describing the input image.

According to some aspects, data engine 1225 is configured to generate the training data. According to some aspects, language generation model 1230 generates the augmented caption using a language generation model 1230.

According to some aspects, machine learning model 1200 obtains training data including a training image, a synthetic caption generated based on the training image, and an augmented caption generated based on the synthetic caption. In some examples, machine learning model 1200 obtains preliminary training data including the training image and an original caption. In some examples, machine learning model 1200 identifies a positive pair including the training image and the synthetic caption or the augmented caption. In some examples, machine learning model 1200 identifies a negative pair including the training image and an additional caption corresponding to an additional training image different from the training image.

In one aspect, machine learning model 1200 includes captioning model 1205, data engine 1225, and language generation model 1230. Captioning model 1205 is an example of, or includes aspects of, the corresponding element described with reference to FIGS. 4 and 6. In one aspect, captioning model 1205 includes image encoder 1210, language encoder 1215, and language decoder 1220.

Image encoder 1210 is an example of, or includes aspects of, the corresponding element described with reference to FIG. 6. Language encoder 1215 is an example of, or includes aspects of, the corresponding element described with reference to FIG. 6. Language decoder 1220 is an example of, or includes aspects of, the corresponding element described with reference to FIG. 6. Data engine 1225 is an example of, or includes aspects of, the corresponding element described with reference to FIG. 4. Language generation model 1230 is an example of, or includes aspects of, the corresponding element described with reference to FIGS. 4 and 7.

Accordingly, a method for image captioning is described. One or more aspects of the method include obtaining an input image; encoding, using an image encoder of a captioning model, the input image to obtain an image embedding; and generating, using a language decoder of the captioning model, a text caption describing the input image, wherein the captioning model is trained using training data including a training image, a synthetic caption generated based on the training image, and an augmented caption generated based on the synthetic caption.

Some examples of the method, apparatus, and non-transitory computer readable medium further include generating a plurality of local embeddings corresponding to a plurality of regions of the input image, respectively, wherein the image embedding comprises one of the plurality of local embeddings. Some examples of the method, apparatus, and non-transitory computer readable medium further include autoregressively decoding the image embedding.

Some examples of the method, apparatus, and non-transitory computer readable medium further include obtaining an input prompt. Some examples further include encoding, using a language encoder of the captioning model, the input prompt to obtain a text embedding. In some aspects, the image embedding and the text embedding are in the same embedding space.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method of training a machine learning model, the method comprising:
obtaining training data including an input image depicting a scene; and
training, using the training data, a captioning model to generate a text caption describing the scene, wherein training the captioning model comprises:
training an image encoder of the captioning model to encode the input image to obtain an image embedding representing the scene; and
training a language decoder of the captioning model to generate the text caption based on the image embedding, wherein the captioning model is trained based on an output of the language decoder.

2. The method of claim 1, wherein training the captioning model further comprises:
iteratively generating synthetic captions using the captioning model and updating the captioning model based on the synthetic captions.

3. The method of claim 1, wherein encoding the input image comprises:
generating a plurality of local embeddings corresponding to a plurality of regions of the input image, respectively, wherein the image embedding comprises one of the plurality of local embeddings.

4. The method of claim 1, wherein generating the text caption comprises:
autoregressively decoding the image embedding.

5. The method of claim 1, further comprising:
obtaining an input prompt; and
encoding, using a language encoder of the captioning model, the input prompt to obtain a text embedding.

6. The method of claim 4, wherein the image embedding and the text embedding are in a same embedding space.

7. A non-transitory computer readable medium storing code for training a machine learning model, the code comprising instructions executable by at least one processor to perform operations comprising:
obtaining training data including an input image;
training, using the training data, a first captioning model to generate a synthetic caption based on the input image;
generating an augmented caption based on the synthetic caption; and
using the synthetic caption and the augmented caption to train a second captioning model.

8. The non-transitory computer readable medium of claim 7, wherein generating the augmented caption comprises:
generating the augmented caption using a language generation model.

9. The non-transitory computer readable medium of claim 7, wherein training the second captioning model comprises:
identifying a positive pair comprising the input image and the synthetic caption or the augmented caption; and
identifying a negative pair comprising the training image and an additional caption corresponding to an additional training image different from the training image.

10. The non-transitory computer readable medium of claim 9, wherein training the second captioning model further comprises:
computing a contrastive loss based on the positive pair and the negative pair; and
updating parameters of the second captioning model based on the contrastive loss.

11. The method of claim 10, wherein:
an image encoder and a language encoder of the second captioning model are updated based on the contrastive loss.

12. The method of claim 6, wherein training the second captioning model comprises:
autoregressively generating a predicted caption;
computing a caption loss based on the predicted caption; and
updating parameters of the second captioning model based on the caption loss.

13. The method of claim 12, wherein:
an image encoder and a language decoder of the second captioning model are updated based on the caption loss.

14. The method of claim 6, wherein training the second captioning model comprises:
iteratively training the second captioning model, generating synthetic captions, generating augmented captions based on the synthetic captions, and retraining the second captioning model.

15. An apparatus comprising:
at least one processor;
at least one memory component coupled with the at least one processor; and
a captioning model comprising parameters stored in the at least one memory component and trained to generate a text caption describing an input image, wherein the captioning model is trained by generating a synthetic caption, generating an augmented caption based on the synthetic caption, and training the captioning model using the synthetic caption and the augmented caption.

16. The apparatus of claim 15, further comprising:
a data engine configured to iteratively generate training data for the captioning model.

17. The apparatus of claim 15, wherein:
the captioning model comprises an image encoder configured to encode the input image to obtain an image embedding.

18. The apparatus of claim 16, wherein:
the captioning model comprises a language encoder configured to encode an input prompt to obtain a text embedding.

19. The apparatus of claim 16, wherein:
the captioning model comprises a language decoder configured to generate a text caption describing the input image.

20. The apparatus of claim 16, further comprising:
a language generation model configured to generate the augmented caption.
